(19) United States
(12) Patent Application Publication
(10) Pub. No.: US 2020/0107377 A1
(43) Pub. Date: Apr. 2, 2020

(54) METHOD AND USER EQUIPMENT FOR PERFORMING RANDOM ACCESS PROCEDURE

(71) Applicant: LG Electronics Inc., Seoul (KR)

(72) Inventors: Jeonggu LEE, Seoul (KR); Sunyoung LEE, Seoul (KR); Seungjune YI, Seoul (KR)

(21) Appl. No.: 16/617,340

(22) PCT Filed: May 24, 2018
(86) PCT No.: PCT/KR2018/005874

§ 371 Date: Nov. 26, 2019

Related U.S. Application Data
(60) Provisional application No. 62/511,349, filed on May 26, 2017.

(51) Int. Cl. H04W 74/08; H04W 74/00; H04W 72/04; H04L 1/18

(52) U.S. Cl. CPC H04W 74/0841; H04W 74/006; H04W 4/70; H04L 1/1812; H04W 72/042

(57) ABSTRACT

A user equipment (UE) of the present invention performs a random access preamble (Msg1) transmission of a random access procedure, receives a random access response (Msg2) of the random access procedure, and performs an Msg3 transmission of the random access procedure. The UE starts a contention resolution timer, which specifies a duration during which the UE is to monitor a physical downlink control channel (PDCCH) after the Msg3 transmission, when performing the Msg3 transmission of the random access procedure. The UE starts a backoff at a time when the UE detects that the Msg3 transmission of the random access procedure is not successful, even before the contention resolution timer expires, if the Msg3 transmission of the random access procedure is a last Msg3 transmission of the random access procedure.

### TECHNICAL FIELD

The present invention relates to a wireless communication system, and more particularly, to a method and apparatus for performing random access procedure.

### BACKGROUND ART

As an example of a mobile communication system to which the present invention is applicable, a 3rd Generation Partnership Project Long Term Evolution (hereinafter, referred to as LTE) communication system is described in brief.

FIG. 1 is a view schematically illustrating a network structure of an E-UMTS as an exemplary radio communication system. An Evolved Universal Mobile Telecommunications System (E-UMTS) is an advanced version of a conventional Universal Mobile Telecommunications System (UMTS) and basic standardization thereof is currently underway in the 3GPP. E-UMTS may be generally referred to as a Long Term Evolution (LTE) system. For details of the technical specifications of the UMTS and E-UMTS, reference can be made to Release 7 and Release 8 of “3rd Generation Partnership Project; Technical Specification Group Radio Access Network”.

Referring to FIG. 1, the E-UMTS includes a User Equipment (UE), eNode Bs (eNBs), and an Access Gateway (AG) which is located at an end of the network (E-UTRAN) and connected to an external network. The eNBs may simultaneously transmit multiple data streams for a broadcast service, a multicast service, and/or a unicast service.

One or more cells may exist per eNB. The cell is set to operate in one of bandwidths such as 1.25, 2.5, 5, 10, 15, and 20 MHz and provides a downlink (DL) or uplink (UL) transmission service to a plurality of UEs in the bandwidth. Different cells may be set to provide different bandwidths. The eNB controls data transmission or reception to and from a plurality of UEs. The eNB transmits DL scheduling information of DL data to a corresponding UE so as to inform the UE of a time/frequency domain in which the DL data is supposed to be transmitted, coding, a data size, and hybrid automatic repeat and request (HARQ)-related information. In addition, the eNB transmits UL scheduling information of UL data to a corresponding UE so as to inform the UE of a time/frequency domain which may be used by the UE, coding, a data size, and HARQ-related information. An interface for transmitting user traffic or control traffic may be used between eNBs. A core network (CN) may include the AG and a network node or the like for user registration of UEs. The AG manages the mobility of a UE on a tracking area (TA) basis. One TA includes a plurality of cells.

Although wireless communication technology has been developed to LTE based on wideband code division multiple access (WCDMA), the demands and expectations of users and service providers are on the rise. In addition, considering other radio access technologies under development, new technological evolution is required to secure high competitiveness in the future. Decrease in cost per bit, increase in service availability, flexible use of frequency bands, a simplified structure, an open interface, appropriate power consumption of UEs, and the like are required.

As more and more communication devices demand larger communication capacity, there is a need for improved mobile broadband communication compared to existing RAT. Also, massive machine type communication (MTC), which provides various services by connecting many devices and objects, is one of the major issues to be considered in the next generation communication. In addition, a communication system design considering a service/UE sensitive to reliability and latency is being discussed. The introduction of next-generation RAT, which takes into account advanced mobile broadband communication, massive MTC (mMTC), and ultra-reliable and low latency communication (URLLC), is being discussed.

### DISCLOSURE OF INVENTION

### Technical Problem

Due to introduction of new radio communication technology, the number of user equipments (UEs) to which a BS should provide a service in a prescribed resource region increases and the amount of data and control information that the BS should transmit to the UEs increases. Since the amount of resources available to the BS for communication with the UE(s) is limited, a new method in which the BS efficiently receives/transmits uplink/downlink data and/or uplink/downlink control information using the limited radio resources is needed.

With development of technologies, overcoming delay or latency has become an important challenge. Applications whose performance critically depends on delay/latency are increasing. Accordingly, a method to reduce delay/latency compared to the legacy system is demanded.

Also, with development of smart devices, a new scheme for efficiently transmitting/receiving a small amount of data or efficiently transmitting/receiving data occurring at a low frequency is required.

The technical objects that can be achieved through the present invention are not limited to what has been particularly described hereinabove and other technical objects not described herein will be more clearly understood by persons skilled in the art from the following detailed description.

### Solution to Problem

In an aspect of the present invention, provided herein is a method for performing a random access procedure by a user equipment (UE). The method comprises: performing a random access preamble (Msg1) transmission of the random access procedure; receiving a random access response (Msg2) of the random access procedure; performing an Msg3 transmission of the random access procedure; starting a contention resolution timer, which specifies a duration during which the UE is to monitor a physical downlink control channel (PDCCH) after the Msg3 transmission, when performing the Msg3 transmission of the random access procedure; and starting a backoff at a time when the UE detects that the Msg3 transmission of the random access procedure is not successful before the contention resolution timer expires, if the Msg3 transmission of the random access procedure is a last Msg3 transmission of the random access procedure.

In another aspect of the present invention, provided herein is a user equipment for performing a random access procedure. The UE comprises: a transceiver, and a processor configured to control the transceiver. The processor is configured to: control the transceiver to perform a random access preamble (Msg1) transmission of the random access procedure; control the transceiver to receive a random access response (Msg2) of the random access procedure; control the transceiver to perform an Msg3 transmission of the random access procedure; start a contention resolution timer, which specifies a duration during which the UE is to monitor a physical downlink control channel (PDCCH) after the Msg3 transmission, when performing the Msg3 transmission of the random access procedure; and start a backoff at a time when it is detected that the Msg3 transmission of the random access procedure is not successful before the contention resolution timer expires, if the Msg3 transmission of the random access procedure is a last Msg3 transmission of the random access procedure.

In each aspect of the present invention, the UE may stop the contention resolution timer at the time when the UE detects that the Msg3 transmission of the random access procedure is not successful, if the Msg3 transmission of the random access procedure is the last Msg3transmission of the random access procedure.

In each aspect of the present invention, the UE may consider that a contention resolution for the random access procedure is not successful if the UE detects that the last Msg3 transmission of the random access procedure is not successful.

In each aspect of the present invention, the UE may further perform a subsequent random access procedure when a backoff time passes after starting the backoff.

In each aspect of the present invention, the UE may further discard a temporary C-RNTI conveyed in the Msg2, if the Msg3 transmission of the random access procedure is the last Msg3 transmission of the random access procedure and if a contention resolution for the random access procedure is not successful.

In each aspect of the present invention, the UE may receive information on a maximum number (maxHARQ-Msg3Tx) of Msg3 transmissions. If CURRENT_TX_NB for the Msg3 transmission is equal to maxHARQ-Msg3Tx minus 1, the Msg3 transmission may be the last Msg3 transmission of the random access procedure, where CURRENT_TX_NB is the number of transmissions that have taken place for Msg3 of the random access procedure.

In each aspect of the present invention, the UE may perform another Msg3 transmission of the random access procedure after the contention resolution timer expires, if the Msg3 transmission is not the last Msg3 transmission of the random access procedure and if the Msg3 transmission is not successful.

In each aspect of the present invention, the Msg3 transmission of the random access procedure may be not successful if a positive acknowledgement for the Msg3 transmission is not received at a HARQ feedback reception time for the Msg3 transmission, if a negative acknowledgement for the Msg3 transmission is received at the HARQ feedback reception time for the Msg3 transmission, if any HARQ feedback for the Msg3 retransmission is received until the HARQ feedback reception time, or if a PDCCH with a new data indicator (NDI) not toggled compared to a previous NDI for a HARQ process used for the Msg3 retransmission is received at the HARQ feedback reception time for the Msg3 transmission.

The above technical solutions are merely some parts of the embodiments of the present invention and various embodiments into which the technical features of the present invention are incorporated can be derived and understood by persons skilled in the art from the following detailed description of the present invention.

### Advantageous Effects of Invention

According to the present invention, radio communication signals can be efficiently transmitted/received. Therefore, overall throughput of a radio communication system can be improved.

According to one embodiment of the present invention, a low cost/complexity UE can perform communication with a base station (BS) at low cost while maintaining compatibility with a legacy system.

According to one embodiment of the present invention, the UE can be implemented at low cost/complexity.

According to one embodiment of the present invention, the UE and the BS can perform communication with each other at a narrowband.

According to an embodiment of the present invention, delay/latency occurring during communication between a user equipment and a BS may be reduced.

Also, it is possible to efficiently transmit/receive a small amount of data for smart devices, or efficiently transmit/receive data occurring at a low frequency.

According to an embodiment of the present invention, a small amount of data may be efficiently transmitted/received.

It will be appreciated by persons skilled in the art that the effects that can be achieved through the present invention are not limited to what has been particularly described hereinabove and other advantages of the present invention will be more clearly understood from the following detailed description.

### BRIEF DESCRIPTION OF DRAWINGS

The accompanying drawings, which are included to provide a further understanding of the invention, illustrate embodiments of the invention and together with the description serve to explain the principle of the invention.

FIG. 1 is a view schematically illustrating a network structure of an E-UMTS as an exemplary radio communication system.

FIG. 2 is a block diagram illustrating network structure of an evolved universal mobile telecommunication system (E-UMTS).

FIG. 3 is a block diagram depicting architecture of a typical E-UTRAN and a typical EPC.

FIG. 4 is a diagram showing a control plane and a user plane of a radio interface protocol between a UE and an E-UTRAN based on a 3GPP radio access network standard.

FIG. 5 is a view showing an example of a physical channel structure used in an E-UMTS system.

FIG. 6 illustrates an example of the stop condition for a contention resolution timer.

FIG. 7 shows an example of mac-ContentionResolutionTimer operation according to the present invention.

FIG. 8 is a block diagram illustrating elements of a transmitting device 100 and a receiving device 200 for implementing the present invention.

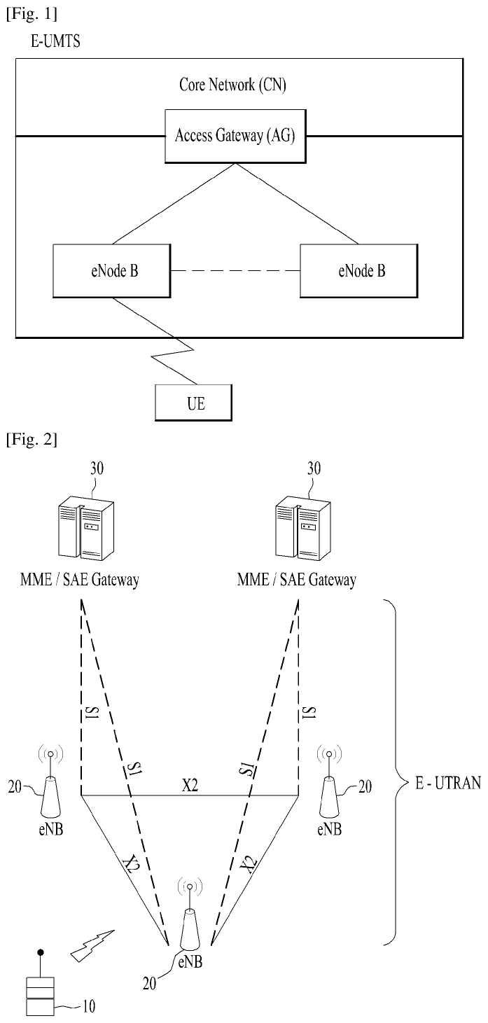

### MODE FOR THE INVENTION

Reference will now be made in detail to the exemplary embodiments of the present invention, examples of which are illustrated in the accompanying drawings. The detailed description, which will be given below with reference to the accompanying drawings, is intended to explain exemplary embodiments of the present invention, rather than to show the only embodiments that can be implemented according to the invention. The following detailed description includes specific details in order to provide a thorough understanding of the present invention. However, it will be apparent to those skilled in the art that the present invention may be practiced without such specific details.

In some instances, known structures and devices are omitted or are shown in block diagram form, focusing on important features of the structures and devices, so as not to obscure the concept of the present invention. The same reference numbers will be used throughout this specification to refer to the same or like parts.

The following techniques, apparatuses, and systems may be applied to a variety of wireless multiple access systems. Examples of the multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multicarrier frequency division multiple access (MC-FDMA) system. CDMA may be embodied through radio technology such as universal terrestrial radio access (UTRA) or CDMA2000. TDMA may be embodied through radio technology such as global system for mobile communications (GSM), general packet radio service (GPRS), or enhanced data rates for GSM evolution (EDGE). OFDMA may be embodied through radio technology such as institute of electrical and electronics engineers (IEEE) 802.11 (Wi-Fi), IEEE 802.16 (WiMAX), IEEE 802.20, or evolved UTRA (E-UTRA). UTRA is a part of a universal mobile telecommunications system (UMTS). 3rd generation partnership project (3GPP) long term evolution (LTE) is a part of evolved UMTS (E-UMTS) using E-UTRA. 3GPP LTE employs OFDMA in DL and SC-FDMA in UL. LTE-advanced (LTE-A) is an evolved version of 3GPP LTE. For convenience of description, it is assumed that the present invention is applied to 3GPP LTE/LTE-A. However, the technical features of the present invention are not limited thereto. For example, although the following detailed description is given based on a mobile communication system corresponding to the 3GPP LTE/LTE-A system, aspects of the present invention that are not specific to 3GPP LTE/LTE-A are applicable to and other mobile communication systems. Especially the present invention is applicable to the NR system which is recently uprising, as well as the 3GPP LTE/LTE-A system.

For example, the present invention is applicable to contention based communication such as Wi-Fi as well as non-contention based communication as in the 3GPP LTE/LTE-A system in which an eNB allocates a DL/UL time/frequency resource to a UE and the UE receives a DL signal and transmits a UL signal according to resource allocation of the eNB. In a non-contention based communication scheme, an access point (AP) or a control node for controlling the AP allocates a resource for communication between the UE and the AP, whereas, in a contention based communication scheme, a communication resource is occupied through contention between UEs which desire to access the AP. The contention based communication scheme will now be described in brief. One type of the contention based communication scheme is carrier sense multiple access (CSMA). CSMA refers to a probabilistic media access control (MAC) protocol for confirming, before a node or a communication device transmits traffic on a shared transmission medium (also called a shared channel) such as a frequency band, that there is no other traffic on the same shared transmission medium. In CSMA, a transmitting device determines whether another transmission is being performed before attempting to transmit traffic to a receiving device. In other words, the transmitting device attempts to detect presence of a carrier from another transmitting device before attempting to perform transmission. Upon sensing the carrier, the transmitting device waits for another transmission device which is performing transmission to finish transmission, before performing transmission thereof. Consequently, CSMA can be a communication scheme based on the principle of “sense before transmit” or “listen before talk”. A scheme for avoiding collision between transmitting devices in the contention based communication system using CSMA includes carrier sense multiple access with collision detection (CSMA/CD) and/or carrier sense multiple access with collision avoidance (CSMA/CA). CSMA/CD is a collision detection scheme in a wired local area network (LAN) environment. In CSMA/CD, a personal computer (PC) or a server which desires to perform communication in an Ethernet environment first confirms whether communication occurs on a network and, if another device carries data on the network, the PC or the server waits and then transmits data. That is, when two or more users (e.g. PCs, UEs, etc.) simultaneously transmit data, collision occurs between simultaneous transmission and CSMA/CD is a scheme for flexibly transmitting data by monitoring collision. A transmitting device using CSMA/CD adjusts data transmission thereof by sensing data transmission performed by another device using a specific rule. CSMA/CA is a MAC protocol specified in IEEE 802.11 standards. A wireless LAN (WLAN) system conforming to IEEE 802.11 standards does not use CSMA/CD which has been used in IEEE 802.3 standards and uses CA, i.e. a collision avoidance scheme. Transmission devices always sense carrier of a network and, if the network is empty, the transmission devices wait for determined time according to locations thereof registered in a list and then transmit data. Various methods are used to determine priority of the transmission devices in the list and to reconfigure priority. In a system according to some versions of IEEE 802.11 standards, collision may occur and, in this case, a collision sensing procedure is performed. A transmission device using CSMA/CA avoids collision between data transmission thereof and data transmission of another transmission device using a specific rule.

In the present invention, the term “assume” may mean that a subject to transmit a channel transmits the channel in accordance with the corresponding “assumption.” This may also mean that a subject to receive the channel receives or decodes the channel in a form conforming to the “assumption,” on the assumption that the channel has been transmitted according to the “assumption.”

In the present invention, a user equipment (UE) may be a fixed or mobile device. Examples of the UE include various devices that transmit and receive user data and/or various kinds of control information to and from a base station (BS). The UE may be referred to as a terminal equipment (TE), a mobile station (MS), a mobile terminal (MT), a user terminal (UT), a subscriber station (SS), a wireless device, a personal digital assistant (PDA), a wireless modem, a handheld device, etc. In addition, in the present invention, a BS generally refers to a fixed station that performs communication with a UE and/or another BS, and exchanges various kinds of data and control information with the UE and another BS. The BS may be referred to as an advanced base station (ABS), a node-B (NB), an evolved node-B (eNB), a base transceiver system (BTS), an access point (AP), a processing server (PS), etc. Especially, a BS of the UMTS is often referred to as a NB, a BS of the EPC/LTE is often referred to as an eNB, and a BS of the new radio (NR) system is often referred to as a gNB. For convenience of description, a BS will be referred to as an eNB.

In the present invention, a node refers to a fixed point capable of transmitting/receiving a radio signal through communication with a UE. Various types of eNBs may be used as nodes irrespective of the terms thereof. For example, a BS, a node B (NB), an e-node B (eNB), a pico-cell eNB (PeNB), a home eNB (HeNB), a relay, a repeater, etc. may be a node. In addition, the node may not be an eNB. For example, the node may be a radio remote head (RRH) or a radio remote unit (RRU). The RRH or RRU generally has a lower power level than a power level of an eNB. Since the RRH or RRU (hereinafter, RRH/RRU) is generally connected to the eNB through a dedicated line such as an optical cable, cooperative communication between RRH/RRU and the eNB can be smoothly performed in comparison with cooperative communication between eNBs connected by a radio line. At least one antenna is installed per node. The antenna may mean a physical antenna or mean an antenna port or a virtual antenna.

In the present invention, a cell refers to a prescribed geographical area to which one or more nodes provide a communication service. Accordingly, in the present invention, communicating with a specific cell may mean communicating with an eNB or a node which provides a communication service to the specific cell. In addition, a DL/UL signal of a specific cell refers to a DL/UL signal from/to an eNB or a node which provides a communication service to the specific cell. A node providing UL/DL communication services to a UE is called a serving node and a cell to which UL/DL communication services are provided by the serving node is especially called a serving cell.

Meanwhile, a 3GPP LTE/LTE-A system uses the concept of a cell in order to manage radio resources and a cell associated with the radio resources is distinguished from a cell of a geographic region.

A “cell” of a geographic region may be understood as coverage within which a node can provide service using a carrier and a “cell” of a radio resource is associated with bandwidth (BW) which is a frequency range configured by the carrier. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of a radio resource used by the node. Accordingly, the term “cell” may be used to indicate service coverage of the node sometimes, a radio resource at other times, or a range that a signal using a radio resource can reach with valid strength at other times.

Meanwhile, the 3GPP LTE-A standard uses the concept of a cell to manage radio resources. The “cell” associated with the radio resources is defined by combination of downlink resources and uplink resources, that is, combination of DL component carrier (CC) and UL CC. The cell may be configured by downlink resources only, or may be configured by downlink resources and uplink resources. If carrier aggregation is supported, linkage between a carrier frequency of the downlink resources (or DL CC) and a carrier frequency of the uplink resources (or UL CC) may be indicated by system information. For example, combination of the DL resources and the UL resources may be indicated by linkage of system information block type 2 (SIB2). In this case, the carrier frequency means a center frequency of each cell or CC. A cell operating on a primary frequency may be referred to as a primary cell (Pcell) or PCC, and a cell operating on a secondary frequency may be referred to as a secondary cell (Scell) or SCC. The carrier corresponding to the Pcell on downlink will be referred to as a downlink primary CC (DL PCC), and the carrier corresponding to the Pcell on uplink will be referred to as an uplink primary CC (UL PCC). A Scell means a cell that may be configured after completion of radio resource control (RRC) connection establishment and used to provide additional radio resources. The Scell may form a set of serving cells for the UE together with the Pcell in accordance with capabilities of the UE. The carrier corresponding to the Scell on the downlink will be referred to as downlink secondary CC (DL SCC), and the carrier corresponding to the Scell on the uplink will be referred to as uplink secondary CC (UL SCC). Although the UE is in RRC-CONNECTED state, if it is not configured by carrier aggregation or does not support carrier aggregation, a single serving cell configured by the Pcell only exists.

For terms and technologies which are not specifically described among the terms of and technologies employed in this specification, 3GPP LTE/LTE-A standard documents, for example, 3GPP TS 36.211, 3GPP TS 36.212, 3GPP TS 36.213, 3GPP TS 36.321, 3GPP TS 36.322, 3GPP TS 36.300, 3GPP TS 36.323 and 3GPP TS 36.331 may be referenced.

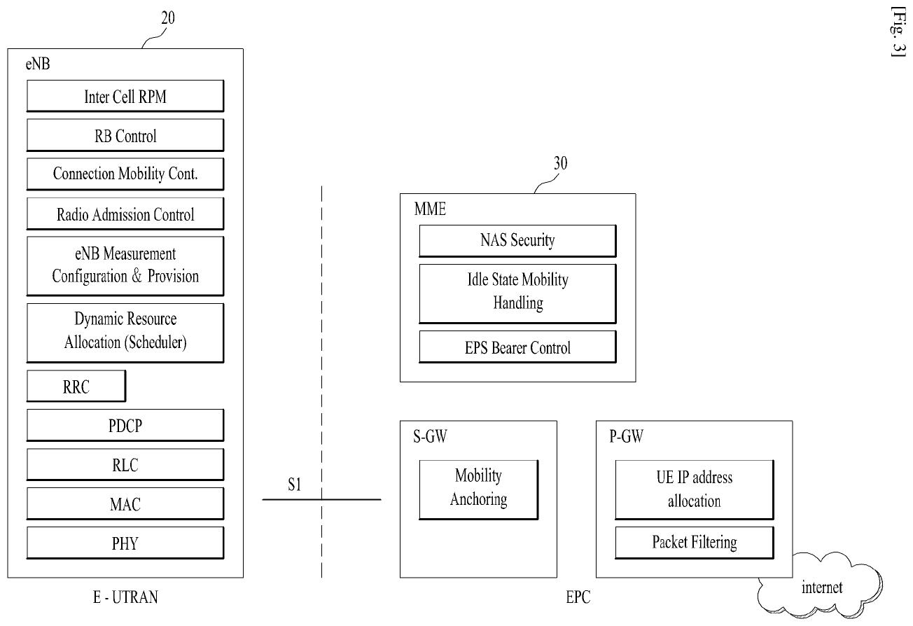

FIG. 2 is a block diagram illustrating network structure of an evolved universal mobile telecommunication system (E-UMTS). The E-UMTS may be also referred to as an LTE system. The communication network is widely deployed to provide a variety of communication services such as voice (VoIP) through IMS and packet data.

As illustrated in FIG. 2, the E-UMTS network includes an evolved UMTS terrestrial radio access network (E-UTRAN), an Evolved Packet Core (EPC) and one or more user equipment. The E-UTRAN may include one or more evolved NodeB (eNodeB) 20, and a plurality of user equipment (UE) 10 may be located in one cell. One or more E-UTRAN mobility management entity (MME)/system architecture evolution (SAE) gateways 30 may be positioned at the end of the network and connected to an external network.

As used herein, “downlink” refers to communication from eNB 20 to UE 10, and “uplink” refers to communication from the UE to an eNB.

FIG. 3 is a block diagram depicting architecture of a typical E-UTRAN and a typical EPC.

As illustrated in FIG. 3, an eNB 20 provides end points of a user plane and a control plane to the UE 10. MME/SAE gateway 30 provides an end point of a session and mobility management function for UE 10. The eNB and MME/SAE gateway may be connected via an S1 interface.

The eNB 20 is generally a fixed station that communicates with a UE 10, and may also be referred to as a base station (BS) or an access point. One eNB 20 may be deployed per cell. An interface for transmitting user traffic or control traffic may be used between eNBs 20.

The MME provides various functions including NAS signaling to eNBs 20, NAS signaling security, AS Security control, Inter CN node signaling for mobility between 3GPP access networks, Idle mode UE Reachability (including control and execution of paging retransmission), Tracking Area list management (for UE in idle and active mode), PDN GW and Serving GW selection, MME selection for handovers with MME change, SGSN selection for handovers to 2G or 3G 3GPP access networks, roaming, authentication, bearer management functions including dedicated bearer establishment, support for PWS (which includes ETWS and CMAS) message transmission. The SAE gateway host provides assorted functions including Per-user based packet filtering (by e.g. deep packet inspection), Lawful Interception, UE IP address allocation, Transport level packet marking in the downlink, UL and DL service level charging, gating and rate enforcement, DL rate enforcement based on APN-AMBR. For clarity MME/SAE gateway 30 will be referred to herein simply as a “gateway,” but it is understood that this entity includes both an MME and an SAE gateway.

A plurality of nodes may be connected between eNB 20 and gateway 30 via the S1 interface. The eNBs 20 may be connected to each other via an X2 interface and neighboring eNBs may have a meshed network structure that has the X2 interface.

As illustrated, eNB 20 may perform functions of selection for gateway 30, routing toward the gateway during a Radio Resource Control (RRC) activation, scheduling and transmitting of paging messages, scheduling and transmitting of Broadcast Channel (BCCH) information, dynamic allocation of resources to UEs 10 in both uplink and downlink, configuration and provisioning of eNB measurements, radio bearer control, radio admission control (RAC), and connection mobility control in LTE_ACTIVE state. In the EPC, and as noted above, gateway 30 may perform functions of paging origination, LTE-IDLE state management, ciphering of the user plane, System Architecture Evolution (SAE) bearer control, and ciphering and integrity protection of Non-Access Stratum (NAS) signaling.

The EPC includes a mobility management entity (MME), a serving-gateway (S-GW), and a packet data network-gateway (PDN-GW). The MME has information about connections and capabilities of UEs, mainly for use in managing the mobility of the UEs. The S-GW is a gateway having the E-UTRAN as an end point, and the PDN-GW is a gateway having a packet data network (PDN) as an end point.

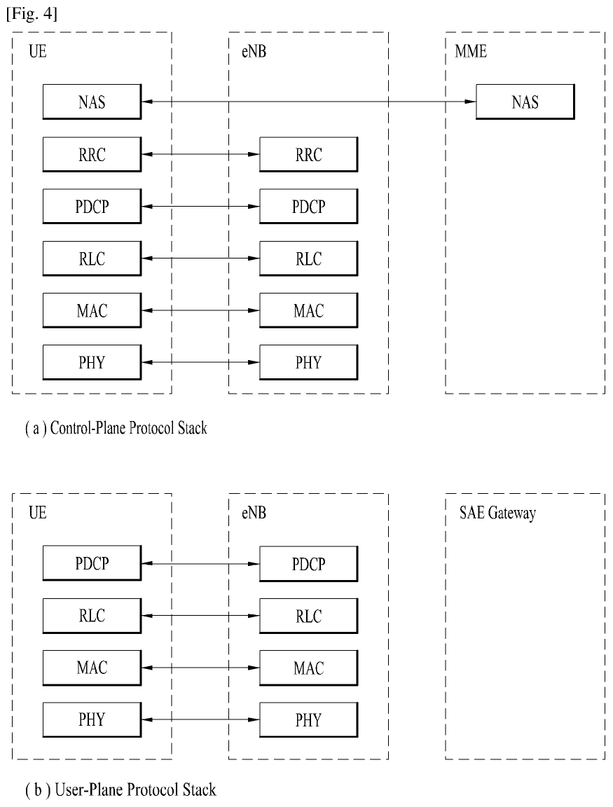

FIG. 4 is a diagram showing a control plane and a user plane of a radio interface protocol between a UE and an E-UTRAN based on a 3GPP radio access network standard. The control plane refers to a path used for transmitting control messages used for managing a call between the UE and the E-UTRAN. The user plane refers to a path used for transmitting data generated in an application layer, e.g., voice data or Internet packet data.

A physical (PHY) layer of a first layer (i.e. L1 layer) provides an information transfer service to a higher layer using a physical channel. The PHY layer is connected to a medium access control (MAC) layer located on the higher layer via a transport channel. Data is transported between the MAC layer and the PHY layer via the transport channel. Data is transported between a physical layer of a transmitting side and a physical layer of a receiving side via physical channels. The physical channels use time and frequency as radio resources. In detail, the physical channel is modulated using an orthogonal frequency division multiple access (OFDMA) scheme in downlink and is modulated using a single carrier frequency division multiple access (SC-FDMA) scheme in uplink.

The MAC layer of a second layer (i.e. L2 layer) provides a service to a radio link control (RLC) layer of a higher layer via a logical channel. The RLC layer of the second layer supports reliable data transmission. A function of the RLC layer may be implemented by a functional block of the MAC layer. A packet data convergence protocol (PDCP) layer of the second layer performs a header compression function to reduce unnecessary control information for efficient transmission of an Internet protocol (IP) packet such as an IP version 4 (IPv4) packet or an IP version 6 (IPv6) packet in a radio interface having a relatively small bandwidth.

A radio resource control (RRC) layer located at the bottom of a third layer is defined only in the control plane. The RRC layer controls logical channels, transport channels, and physical channels in relation to configuration, re-configuration, and release of radio bearers (RBs). An RB refers to a service that the second layer provides for data transmission between the UE and the E-UTRAN. To this end, the RRC layer of the UE and the RRC layer of the E-UTRAN exchange RRC messages with each other.

Radio bearers are roughly classified into (user) data radio bearers (DRBs) and signaling radio bearers (SRBs). SRBs are defined as radio bearers (RBs) that are used only for the transmission of RRC and NAS messages.

One cell of the eNB is set to operate in one of bandwidths such as 1.25, 2.5, 5, 10, 15, and 20 MHz and provides a downlink or uplink transmission service to a plurality of UEs in the bandwidth. Different cells may be set to provide different bandwidths.

Downlink transport channels for transmission of data from the E-UTRAN to the UE include a broadcast channel (BCH) for transmission of system information, a paging channel (PCH) for transmission of paging messages, and a downlink shared channel (SCH) for transmission of user traffic or control messages. Traffic or control messages of a downlink multicast or broadcast service may be transmitted through the downlink SCH and may also be transmitted through a separate downlink multicast channel (MCH).

Uplink transport channels for transmission of data from the UE to the E-UTRAN include a random access channel (RACH) for transmission of initial control messages and an uplink SCH for transmission of user traffic or control messages. Logical channels that are defined above the transport channels and mapped to the transport channels include a broadcast control channel (BCCH), a paging control channel (PCCH), a common control channel (CCCH), a multicast control channel (MCCH), and a multicast traffic channel (MTCH).

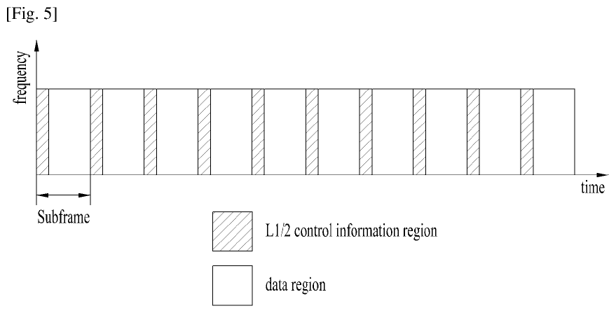

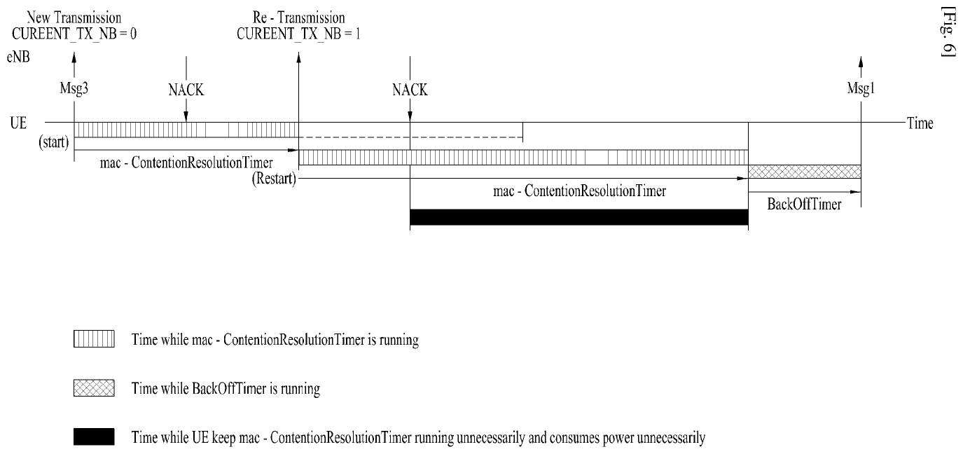

FIG. 5 is a view showing an example of a physical channel structure used in an E-UMTS system. A physical channel includes several subframes on a time axis and several subcarriers on a frequency axis. Here, one subframe includes a plurality of symbols on the time axis. One subframe includes a plurality of resource blocks and one resource block includes a plurality of symbols and a plurality of subcarriers. In addition, each subframe may use certain subcarriers of certain symbols (e.g., a first symbol) of a subframe for a physical downlink control channel (PDCCH), that is, an L1/L2 control channel. The PDCCH carries scheduling assignments and other control information. In FIG. 5, an L1/L2 control information transmission area (PDCCH) and a data area (PDSCH) are shown. In one embodiment, a radio frame of 10 ms is used and one radio frame includes 10 subframes. In addition, one subframe includes two consecutive slots. The length of one slot may be 0.5 ms. In addition, one subframe includes a plurality of OFDM symbols and a portion (e.g., a first symbol) of the plurality of OFDM symbols may be used for transmitting the L1/L2 control information.

A radio frame may have different configurations according to duplex modes. In FDD mode for example, since DL transmission and UL transmission are discriminated according to frequency, a radio frame for a specific frequency band operating on a carrier frequency includes either DL subframes or UL subframes. In TDD mode, since DL transmission and UL transmission are discriminated according to time, a radio frame for a specific frequency band operating on a carrier frequency includes both DL subframes and UL subframes.

A time interval in which one subframe is transmitted is defined as a transmission time interval (TTI). Time resources may be distinguished by a radio frame number (or radio frame index), a subframe number (or subframe index), a slot number (or slot index), and the like. TTI refers to an interval during which data may be scheduled. For example, in the current LTE/LTE-A system, a opportunity of transmission of an UL grant or a DL grant is present every 1 ms, and the UL/DL grant opportunity does not exists several times in less than 1 ms. Therefore, the TTI in the current LTE/LTE-A system is 1 ms.

A base station and a UE mostly transmit/receive data via a PDSCH, which is a physical channel, using a DL-SCH which is a transmission channel, except a certain control signal or certain service data. Information indicating to which UE (one or a plurality of UEs) PDSCH data is transmitted and how the UE receive and decode PDSCH data is transmitted in a state of being included in the PDCCH.

For example, in one embodiment, a certain PDCCH is CRC-masked with a radio network temporary identity (RNTI) “A” and information about data is transmitted using a radio resource “B” (e.g., a frequency location) and transmission format information “C” (e.g., a transmission block size, modulation, coding information or the like) via a certain subframe. Then, one or more UEs located in a cell monitor the PDCCH using its RNTI information. And, a specific UE with RNTI “A” reads the PDCCH and then receive the PDSCH indicated by B and C in the PDCCH information.

If a UE is powered on or newly enters a cell, the UE performs an initial cell search procedure of acquiring time and frequency synchronization with the cell and detecting a physical cell identity N^{cell}_{ID} of the cell. To this end, the UE may establish synchronization with the eNB by receiving synchronization signals, e.g. a primary synchronization signal (PSS) and a secondary synchronization signal (SSS), from the eNB and obtain information such as a cell identity (ID). The UE having finished initial cell search may perform the random access procedure to complete access to the eNB. To this end, the UE may transmit a preamble through a physical random access channel (PRACH), and receive a response message which is a response to the preamble through a PDCCH and PDSCH. In the case of contention-based random access, transmission of an additional PRACH and a contention resolution procedure for the PDCCH and a PDSCH corresponding to the PDCCH may be performed. After performing the procedure described above, the UE may perform PDCCH/PDSCH reception and PUSCH/PUCCH transmission as a typical procedure of transmission of an uplink/downlink signal.

The random access procedure is also referred to as a random access channel (RACH) procedure. The random access procedure is common procedure for FDD and TDD, and one procedure irrespective of cell size and the number of serving cells when carrier aggregation (CA) is configured. The random access procedure is used for various purposes including initial access, adjustment of uplink synchronization, resource assignment, and handover. Random access procedures are classified into a contention-based procedure and a dedicated (i.e., non-contention-based) procedure. The contention-based random access procedure is used for general operations including initial access, while the dedicated random access procedure is used for limited operations such as handover. In the contention-based random access procedure, the UE randomly selects a RACH preamble sequence. Accordingly, it is possible that multiple UEs transmit the same RACH preamble sequence at the same time. Thereby, a contention resolution procedure needs to be subsequently performed. On the other hand, in the dedicated random access procedure, the UE uses an RACH preamble sequence that the eNB uniquely allocates to the UE. Accordingly, the random access procedure may be performed without contention with other UEs.

Referring to 3GPP TS 36.300, the contention-based random access procedure includes the following four steps. Messages/transmissions in Steps 1 to 4 given below may be referred to as Msg1 to Msg4, respectively.

1) Step 1: Random Access Preamble on RACH in uplink (Msg1 from UE to eNB):

>There are two possible groups defined and one is optional. If both groups are configured the size of message 3 (i.e., Msg3) and the pathloss are used to determine which group a preamble is selected from. The group to which a preamble belongs provides an indication of the size of the Msg3 and the radio conditions at the UE. The preamble group information along with the necessary thresholds are broadcast on system information.

2) Step 2: Random Access Response generated by MAC on DL-SCH (Msg2 from eNB to UE):

>Semi-synchronous (within a flexible window of which the size is one or more TTI) with message 1 (i.e., Msg1);

>No HARQ;

>Addressed to RA-RNTI on PDCCH;

>Conveys at least RA-preamble identifier, Timing Alignment information for the pTAG, initial UL grant and assignment of Temporary C-RNTI (which may or may not be made permanent upon Contention Resolution);

>Intended for a variable number of UEs in one DL-SCH message.

3) Step 3: First scheduled UL transmission on UL-SCH (Msg3 from UE to eNB):

>Uses HARQ;

>Size of the transport blocks depends on the UL grant conveyed in Step 2.

>For initial access:

>>Conveys the RRC Connection Request generated by the RRC layer and transmitted via CCCH;

>>Conveys at least NAS UE identifier but no NAS message;

>>RLC TM: no segmentation.

>For RRC Connection Re-establishment procedure:

>>Conveys the RRC Connection Re-establishment Request generated by the RRC layer and transmitted via CCCH;

>>RLC TM: no segmentation;

>>Does not contain any NAS message.

>After handover, in the target cell:

>>Conveys the ciphered and integrity protected RRC Handover Confirm generated by the RRC layer and transmitted via DCCH;

>>Conveys the C-RNTI of the UE (which was allocated via the Handover Command);

>>Includes an uplink Buffer Status Report when possible.

>For other events:

>>Conveys at least the C-RNTI of the UE;

>In the procedure to resume the RRC connection:

>>Conveys the RRC Connection Resume Request generated by the RRC layer and transmitted via CCCH;

>>Conveys a Resume ID to resume the RRC connection;

>For NB-IoT:

>>In the procedure to setup the RRC connection:

>>>An indication of the amount of data for subsequent transmission(s) on SRB or DRB can be indicated.

4) Step 4: Contention Resolution on DL (Msg4 from eNB to UE):

>Early contention resolution shall be used i.e. eNB does not wait for NAS reply before resolving contention;

>Not synchronised with Msg3;

>HARQ is supported;

>Addressed to:

>>The Temporary C-RNTI on PDCCH for initial access and after radio link failure;

>>The C-RNTI on PDCCH for UE in RRC_CONNECTED.

>>HARQ feedback is transmitted only by the UE which detects its own UE identity, as provided in Msg3, echoed in the Contention Resolution message;

>>For initial access and RRC Connection Re-establishment procedure, no segmentation is used (RLC-TM).

The Temporary C-RNTI is promoted to C-RNTI for a UE which detects random access (RA) success and does not already have a C-RNTI; it is dropped by others. A UE which detects RA success and already has a C-RNTI, resumes using its C-RNTI. When CA is configured, the first three steps of the contention based random access procedures occur on the PCell while contention resolution (Step 4) can be cross-scheduled by the PCell. When DC is configured, the first three steps of the contention based random access procedures occur on the PCell in MCG and PSCell in SCG. When CA is configured in SCG, the first three steps of the contention based random access procedures occur on the PSCell while contention resolution (Step 4) can be cross-scheduled by the PSCell.

In summary, after transmitting the RACH preamble (Msg1) of an RA procedure, the UE attempts to receive a random access response (RAR) within a preset time window (i.e., RAR window). Specifically, the UE attempts to detect a PDCCH with RA-RNTI (Random Access RNTI) (hereinafter, RA-RNTI PDCCH) (e.g., CRC is masked with RA-RNTI on the PDCCH) in the time window. In detecting the RA-RNTI PDCCH, the UE checks the PDSCH for presence of an RAR directed thereto. The RAR includes timing advance (TA) information indicating timing offset information for UL synchronization, UL resource allocation information (UL grant information), and a random UE identifier (e.g., temporary cell-RNTI (TC-RNTI)). The RAR may contain a backoff parameter. The UE may perform UL transmission (i.e., Msg3) according to the resource allocation information and the TA value in the RAR. HARQ is applied to UL transmission corresponding to the RAR. Accordingly, after transmitting Msg3, the UE may receive acknowledgement information (e.g., PHICH) corresponding to Msg3. For example, for FDD and normal HARQ operation, upon detection on a given serving cell of a PDCCH/EPDCCH with DCI format 0/4 and/or a PHICH transmission in subframe n intended for a UE, the UE performs a corresponding PUSCH transmission in subframe n+4 according to the PDCCH/EPDCCH and PHICH information if a transport block corresponding to the HARQ process of the PUSCH transmission is generated. In other words, for FDD, an HARQ-ACK received on the PHICH assigned to a UE in subframe i is associated with the PUSCH transmission in subframe i-4.

The random access procedure is controlled by a MAC layer. For example, a MAC entity perform Contention Resolution based on either C-RNTI on PDCCH of the SpCell or UE Contention Resolution Identity on DL-SCH. Referring to 3GPP TS 36.321, once Msg3 is transmitted, the MAC entity shall:

>except for a BL UE or a UE in enhanced coverage, or a NB-IoT UE, start mac-ContentionResolutionTimer and restart mac-ContentionResolutionTimer at each HARQ retransmission;

>for a BL UE or a UE in enhanced coverage, or a NB-IoT UE, start mac-ContentionResolutionTimer and restart mac-ContentionResolutionTimer at each HARQ retransmission of the bundle in the subframe containing the last repetition of the corresponding PUSCH transmission;

>regardless of the possible occurrence of a measurement gap or Sidelink Discovery Gap for Reception, monitor the PDCCH until mac-ContentionResolutionTimer expires or is stopped;

>if notification of a reception of a PDCCH transmission is received from lower layers, the MAC entity shall:

>>if the C-RNTI MAC control element was included in Msg3:

>>>if the Random Access procedure was initiated by the MAC sublayer itself or by the RRC sublayer and the PDCCH transmission is addressed to the C-RNTI and contains an UL grant for a new transmission; or

>>>if the Random Access procedure was initiated by a PDCCH order and the PDCCH transmission is addressed to the C-RNTI:

>>>>consider this Contention Resolution successful;

>>>>stop mac-ContentionResolutionTimer;

>>>>discard the Temporary C-RNTI;

>>>>if the UE is an NB-IoT UE and is configured with a non-anchor carrier:

>>>>>the UL grant or DL assignment contained in the PDCCH transmission on the anchor carrier is valid only for the non-anchor carrier.

>>>>consider this Random Access procedure successfully completed.

>>else if the CCCH service data unit (SDU) was included in Msg3 and the PDCCH transmission is addressed to its Temporary C-RNTI:

>>>if the MAC PDU is successfully decoded:

>>>>stop mac-ContentionResolutionTimer;

>>>>if the MAC PDU contains a UE Contention Resolution Identity MAC control element; and

>>>>if the UE Contention Resolution Identity included in the MAC control element matches the 48 first bits of the CCCH SDU transmitted in Msg3:

>>>>>consider this Contention Resolution successful and finish the disassembly and demultiplexing of the MAC PDU;

>>>>>set the C-RNTI to the value of the Temporary C-RNTI;

>>>>>discard the Temporary C-RNTI;

>>>>>consider this Random Access procedure successfully completed.

>>>>else

>>>>>discard the Temporary C-RNTI;

>>>>>consider this Contention Resolution not successful and discard the successfully decoded MAC PDU.

>if mac-ContentionResolutionTimer expires:

>>discard the Temporary C-RNTI;

>>consider the Contention Resolution not successful.

>if the Contention Resolution is considered not successful the MAC entity shall:

>>flush the HARQ buffer used for transmission of the MAC protocol data unit (PDU) in the Msg3 buffer;

>>if the notification of power ramping suspension has not been received from lower layers:

>>>increment PREAMBLE_TRANSMISSION_COUNTER by 1;

>>if the UE is an NB-IoT UE, a BL UE or a UE in enhanced coverage:

>>>if PREAMBLE_TRANSMISSION_COUNTER=preambleTransMax-CE+1:

>>>>indicate a Random Access problem to upper layers.

>>» if NB-IoT:

>>>>>consider the Random Access procedure unsuccessfully completed;

>>else:

>>>if PREAMBLE_TRANSMISSION_COUNTER=preambleTransMax+1:

>>>>indicate a Random Access problem to upper layers.

>>based on the backoff parameter, select a random backoff time according to a uniform distribution between 0 and the backoff parameter value;

>>delay the subsequent Random Access transmission (i.e. subsequent Random Access procedure) by the backoff time;

>>proceed to the selection of a Random Access Resource (for the subsequent Random Access procedure).

The Contention Resolution Timer ‘mac-ContentionResolutionTimer’ specifies the number of consecutive subframe(s) during which an MAC entity of a UE shall monitor the PDCCH after Msg3 is transmitted. The parameter ‘mac-ContentionResolutionTimer preambleTransMax or preambleTransMax-CE is configured to UE(s) via RRC signalling by the eNB.

As mentioned above, Contention Resolution (i.e., Step 4) uses HARQ. One of the functions supported by the MAC layer is the error correction through HARQ. There is one HARQ entity at the MAC entity for each serving cell which maintains a number of parallel HARQ processes allowing transmissions to take place continuously while waiting for the HARQ feedback on the successful or unsuccessful reception of previous transmissions. For example, there are a maximum of 8 or 16 UL HARQ processes per serving cell for FDD. At a given TTI, if an uplink grant is indicated for the TTI, the HARQ entity identifies the HARQ process(es) for which a transmission should take place. It also routes the received HARQ feedback (ACK/NACK information), MCS and resource, relayed by the physical layer, to the appropriate HARQ process(es). Each HARQ process is associated with a HARQ buffer.

For synchronous HARQ, each HARQ process maintains a state variable CURRENT_TX_NB, which indicates the number of transmissions that have taken place for the MAC PDU currently in the buffer, and a state variable HARQ_FEEDBACK, which indicates the HARQ feedback for the MAC PDU currently in the buffer. When the HARQ process is established, CURRENT_TX_NB is initialized to 0. The sequence of redundancy versions is 0, 2, 3, 1. The variable CURRENT_IRV is an index into the sequence of redundancy versions. This variable is up-dated modulo 4. New transmissions are performed on the resource and with the MCS indicated on PDCCH or Random Access Response. Adaptive retransmissions are performed on the resource and, if provided, with the MCS indicated on PDCCH. Non-adaptive retransmission is performed on the same resource and with the same MCS as was used for the last made transmission attempt. For synchronous HARQ, the MAC entity is configured with a maximum number of Msg3 HARQ transmissions by RRC: maxHARQ-Msg3Tx. For transmission of a MAC PDU stored in the Msg3 buffer, the maximum number of transmissions is set to maxHARQ-Msg3Tx.

When the HARQ feedback is received for this TB, the HARQ process sets HARQ_FEEDBACK to the received value.

If the HARQ entity requests a new transmission, the HARQ process shall:

>if UL HARQ operation is synchronous:

>>set CURRENT_TX_NB to 0;

>>set HARQ_FEEDBACK to NACK;

>>set CURRENT_IRV to 0;

>else:

>>set CURRENT_IRV to the index corresponding to the redundancy version value provided in the HARQ information;

>store the MAC PDU in the associated HARQ buffer;

>store the uplink grant received from the HARQ entity;

>generate a transmission as described below.

If the HARQ entity requests a retransmission, the HARQ process shall:

>if UL HARQ operation is synchronous:

>>increment CURRENT_TX_NB by 1;

>if the HARQ entity requests an adaptive retransmission:

>>store the uplink grant received from the HARQ entity;

>>set CURRENT_IRV to the index corresponding to the redundancy version value provided in the HARQ information;

>>if UL HARQ operation is synchronous:

>>>set HARQ_FEEDBACK to NACK;

>>generate a transmission as described below.

>else if the HARQ entity requests a non-adaptive retransmission:

>>if UL HARQ operation is asynchronous or HARQ_FEEDBACK=NACK:

>>>if both skipUplinkTxSPS and fixedRV-NonAdaptive are configured and the uplink grant of the initial transmission of this HARQ process was performed on a configured grant; or

>>>if the uplink grant is a preallocated uplink grant:

>>>>set CURRENT_IRV to 0;

>>>generate a transmission as described below.

To generate a transmission, the HARQ process shall:

>if the MAC PDU was obtained from the Msg3 buffer

>>instruct the physical layer to generate a transmission according to the stored uplink grant with the redundancy version corresponding to the CURRENT_IRV value;

>>increment CURRENT_IRV by 1;

After performing above actions, if UL HARQ operation is synchronous the HARQ process then shall:

>if CURRENT_TX_NB=maximum number of transmissions−1:

>>flush the HARQ buffer;

In the existing 3GPP TS 36.321, mac-ContentionResolutionTimer is only stopped when a PDCCH transmission for Msg4 is addressed to its Temporary C-RNTI and CCCH SDU was included in Msg3; or a PDCCH transmission for the Msg4 is addressed to C-RNTI and the C-RNTI MAC control element was included in the Msg3.

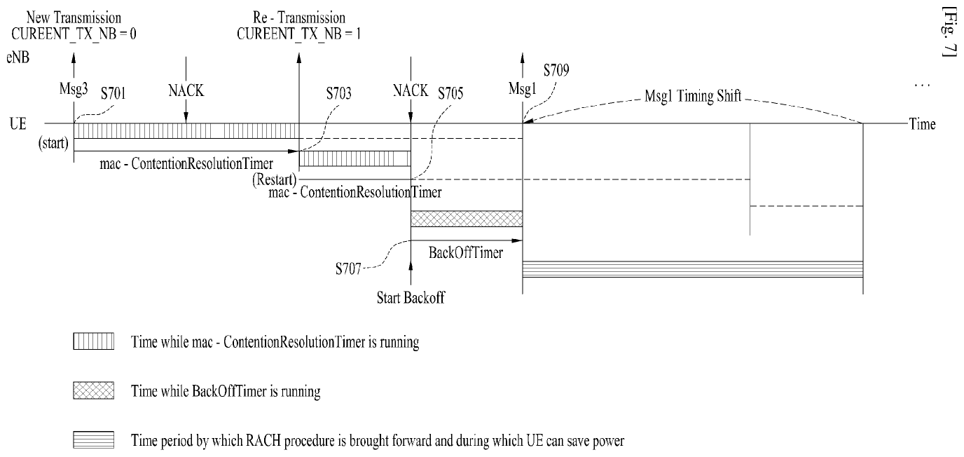

FIG. 6 illustrates an example of the stop condition for a contention resolution timer. Especially, FIG. 6 shows the stop condition for mac-ContentionResolutionTimer after a UE receives NACK for the last Msg3 retransmission in the existing LTE/LTE-A system. In FIG. 6, it is assumed that the UE is configured with mac-ContentionResolutionTimer=16 subframes and maxHARQ-Msg3Tx=2.

In the existing LTE/LTE-A system, as there is no stop condition for mac-ContentionResolutionTimer, even after the last Msg3 retransmission for a RA procedure by a UE is unsuccessfully received by the network, the UE shall keep mac-ContentionResolutionTimer running Only after the expiry of mac-ContentionResolutionTimer started by the last Msg3 retransmission, the UE applies the random backoff time for the next RA procedure. Referring to FIG. 6, after a UE does not receive an ACK at the time for the last Msg3 retransmission, mac-ContentionResolutionTimer is still running. The time (i.e., the time period marked with [symbol] in FIG. 6) during which mac-ContentionResolutionTimer is running after the UE does not receive an ACK at the time for the last Msg3 retransmission could be an unnecessary time because an eNB cannot send Msg4 unless the eNB receives the CCCH SDU or the C-RNTI in the Msg3. This could also have the power of the UE consumed unnecessarily (during the time period marked with [symbol] in FIG. 6). In other words, the UE will not receive any retransmission scheduling for the Msg3 if the last retransmission of the Msg3 is not successfully received by the eNB, and thus UE's waiting for the expiry of mac-ContentionResolutionTimer can only be time and power waste.

Considering the drawback of the existing method of operating mac-ContentionResolutionTimer, the present invention proposes a new method which can reduce the time spent for the RACH procedure and unnecessarily consumed power of the UE.

In the present invention, if an UE does not receive an ACK for the last Msg3 retransmission (i.e., CURRENT_TX_NB=maximum number of transmissions−1), the UE applies RA backoff immediately without waiting for mac-ContentionResolutionTimer expiry. Then the UE transmits an RA preamble after the RA backoff time. In other words, in the present invention, a UE starts a backoff at the time when the UE detects that an Msg3 transmission of an RA procedure is not successful, even before mac-ContentionResolutionTimer expires, if the Msg3 transmission of the RA procedure is a last Msg3 transmission of the RA procedure.

If an UE does not receive an ACK for the last Msg3 retransmission of an RA procedure, then the UE discards the Temporary C-RNTI and considers the contention resolution not successful.

The MAC entity of a UE can be configured with a maximum number of Msg3 HARQ transmissions (maxHARQ-Msg3Tx) by a network (e.g., eNB). For transmission of a MAC PDU stored in the Msg3 buffer, the maximum number of transmissions that the UE can attempt for transmission of the Msg3 MAC PDU shall be set to maxHARQ-Msg3Tx.

In the present invention, a UE is configured with a RACH configuration including mac-ContentionResolutionTimer. A random access preamble (RAP) for a RA procedure can be selected by MAC of the UE based on a selected random access preamble group. For the preamble group selection, the section “5.1.2 Random Access Resource selection” of 3GPP TS 36.321 may be referenced. The MAC of the UE may randomly select an RAP within the selected random access preamble group.

The UE transmits the RAP based on a Preamble-ConfigIndex and an ra-PRACH-MaskIndex. Once the RAP is transmitted, the MAC shall monitor the PDCCH of SpCell (PCell or PSCell) for Random Access Response (RAR) by RA-RNTI. If the RAR reception is successful and the RAP ID in the RAR=Transmitted RAP ID on Msg1, the UE may stop monitoring for RAR. Once Msg3 on a PUSCH is transmitted, the MAC shall (re-)start mac-ContentionResolutionTimer and waits for a HARQ feedback for the Msg3 transmission on the PUSCH. If the Msg3 transmission on the PUSCH is the last Msg3 retransmission for the pending RA procedure, the MAC (re-)starts mac-ContentionResolutionTimer and waits for a HARQ feedback for the last Msg3 retransmission until or at the time of the HARQ feedback reception for the last Msg3 retransmission.

In the present invention, the UE considers that the UE doesn't receive an ACK for the last Msg3 retransmission (in other words, the last Msg3 retransmission is unsuccessful): if the UE doesn't receives a HARQ feedback set to ACK for the last Msg3 retransmission at the time of the HARQ feedback reception; if the UE receives a HARQ feedback set to NACK feedback for the last Msg3 retransmission at the time of the HARQ feedback reception; if the UE doesn't receives any HARQ feedback for the last Msg3 retransmission until the time of the HARQ feedback reception; or if the UE receives a PDCCH with a new data indicator (NDI) not toggled compared to the previous NDI for the HARQ process used for Msg3 retransmission.

If the UE considers that the UE does not receive an ACK for the last Msg3 retransmission (i.e., CURRENT_TX_NB=maximum number of transmissions−1), i.e., if the UE detects that the last Msg3 retransmission is not successful, the UE stops mac-ContentionResolution Timer, if running and starts a backoff operation. For example, when the UE detects that the last Msg3 retransmission is not successful, the UE considers that the contention resolution is not successful and selects a random backoff time according to a uniform distribution between 0 and the Backoff Parameter Value. The UE delays the subsequent Random Access transmission (i.e. RAP transmission for a subsequent RA procedure) by the backoff time. If the backoff time passes, the UE proceeds to the selection of a Random Access Resource for the subsequent RA procedure.

In the present invention, CURRENT_TX_NB refers to the number of Msg3 transmission.

mac-ContentionResolutionTimer specifies the number of consecutive subframe(s) during which the MAC entity shall monitor the PDCCH after Msg3 is transmitted. Msg3 is a message transmitted on UL-SCH containing a C-RNTI MAC CE or CCCH SDU, submitted from upper layer(s) above MAC and associated with the UE Contention Resolution Identity, as part of a random access procedure.

In the present invention, PDCCH may refer to the PDCCH, EPDCCH, MPDCCH, R-PDCCH or NPDCCH, PDSCH may refer to PDSCH or NPDSCH, PUSCH may refer to PUSCH or NPUSCH, and PRACH may refer to PRACH or for NB-IoT to NPRACH.

In the present invention, Random Access RNTI (RA-RNTI) is used on the PDCCH when Random Access Response messages are transmitted. It unambiguously identifies which time-frequency resource was utilized by the MAC entity to transmit the Random Access preamble.

In the present invention, ra-PRACH-MaskIndex defines in which PRACHs within a system frame the MAC entity can transmit a Random Access Preamble.

FIG. 7 shows an example of mac-ContentionResolutionTimer operation according to the present invention. In FIG. 7, it is assumed that the UE is configured with mac-ContentionResolutionTimer=16 subframes and maxHARQ-Msg3Tx=2.

Once Msg3 on PUSCH is transmitted, the MAC of the UE starts mac-ContentionResolutionTimer (S701). UE sets CURRNET_TX_NB to 0.

If the UE does not receive a positive HARQ-ACK (i.e. ACK) for the PUSCH transmission until the time for HARQ feedback reception for the PUSCH transmission (e.g., if the UE does not receives ACK for the PUSCH transmission in subframe i associated with the PUSCH transmission in subframe i-k, where k may be 4 for FDD), the UE performs an Msg3 retransmission (e.g., in subframe i+4 associated with the HARQ ACK/NACK timing in subframe i) and restart ContentionResolutionTimer (S703). The UE increments CURRNET_TX_NB by 1. Then, the CURRNET_TX_NB becomes equal to ‘the maximum number of transmissions−1’. The UE may flush the HARQ buffer related to the Msg3.

After the UE does not receive an ACK for last Msg3 retransmission (i.e., CURRENT_TX_NB=maximum number of transmissions−1), the UE stops mac-ContentionResolutionTimer (S705), if running. At this point, the UE may discard the Temporary C-RNTI and consider the contention resolution not successful. In present invention, the UE may stop mac-ContentionResolutionTimer (S705) and apply a backoff time (S707) immediately when the UE detects that the last Msg3 retransmission of a current RA procedure is unsuccessful. Based on the backoff parameter value, the UE may select a random backoff time according to a uniform distribution between 0 and the backoff parameter value.

The UE delays the subsequent Random Access transmission by the backoff time. The UE proceed to the selection of a Random Access Resource. In other words, the UE can perform an Msg1 transmission of the subsequent random access procedure (S709) if the backoff time passes.

Compared to the existing operation, the present invention can reduce the RA procedure(s) time and save the UE power (at least as much as the time period marked with [symbol] in FIG. 7).

According to the present invention, the UL HARQ operations associated with the RA procedure may be changed in the MAC layer standard documents (e.g. 3GPP TS 36.321). The following table shows a part of the UL HARQ operations defined in the existing 3GPP TS 36.321.

TABLE 1

After performing above actions, if UL HARQ operation is
synchronous the HARQ process then shall:
- if CURRENT_TX_NB = maximum number of transmissions − 1:
- flush the HARQ buffer;

Table 1 may be changed as shown in the following table according to the present invention, for example.

TABLE 2

```
After performing above actions, if UL HARQ operation is
synchronous the HARQ process then shall:
- if CURRENT_TX_NB = maximum number of transmissions − 1:
  - flush the HARQ buffer;
  - if an ACK at the time of the HARQ feedback reception
for the last Msg3 retransmission is not received:
    - stop mac-ContentionResolutionTimer;
    - discard the Temporary C-RNTI;
    - consider the Contention Resolution not successful.
```

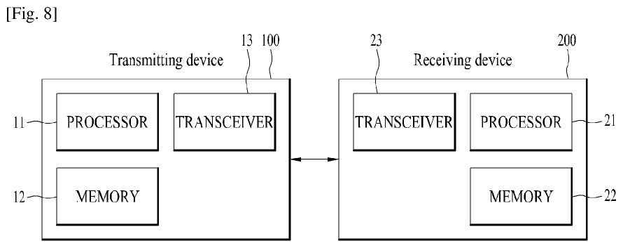

FIG. 8 is a block diagram illustrating elements of a transmitting device 100 and a receiving device 200 for implementing the present invention.

The transmitting device 100 and the receiving device 200 respectively include transceivers 13 and 23 capable of transmitting and receiving radio signals carrying information, data, signals, and/or messages, memories 12 and 22 for storing information related to communication in a wireless communication system, and processors 11 and 21 operationally connected to elements such as the transceivers 13 and 23 and the memories 12 and 22 to control the elements and configured to control the memories 12 and 22 and/or the transceivers 13 and 23 so that a corresponding device may perform at least one of the above-described embodiments of the present invention.

The memories 12 and 22 may store programs for processing and controlling the processors 11 and 21 and may temporarily store input/output information. The memories 12 and 22 may be used as buffers.

The processors 11 and 21 generally control the overall operation of various modules in the transmitting device and the receiving device. Especially, the processors 11 and 21 may perform various control functions to implement the present invention. The processors 11 and 21 may be referred to as controllers, microcontrollers, microprocessors, or microcomputers. The processors 11 and 21 may be implemented by hardware, firmware, software, or a combination thereof. In a hardware configuration, application specific integrated circuits (ASICs), digital signal processors (DSPs), digital signal processing devices (DSPDs), programmable logic devices (PLDs), or field programmable gate arrays (FPGAs) may be included in the processors 11 and 21. Meanwhile, if the present invention is implemented using firmware or software, the firmware or software may be configured to include modules, procedures, functions, etc. performing the functions or operations of the present invention. Firmware or software configured to perform the present invention may be included in the processors 11 and 21 or stored in the memories 12 and 22 so as to be driven by the processors 11 and 21.

The processor 11 of the transmitting device 100 performs predetermined coding and modulation for a signal and/or data scheduled to be transmitted to the outside by the processor 11 or a scheduler connected with the processor 11, and then transfers the coded and modulated data to the transceiver 13. For example, the processor 11 converts a data stream to be transmitted into K layers through demultiplexing, channel coding, scrambling, and modulation. The coded data stream is also referred to as a codeword and is equivalent to a transport block which is a data block provided by a MAC layer. One transport block (TB) is coded into one codeword and each codeword is transmitted to the receiving device in the form of one or more layers. For frequency up-conversion, the transceiver 13 may include an oscillator. The transceiver 13 may include Nₜ (where Nₜ is a positive integer) transmit antennas.

A signal processing process of the receiving device 200 is the reverse of the signal processing process of the transmitting device 100. Under control of the processor 21, the transceiver 23 of the receiving device 200 receives radio signals transmitted by the transmitting device 100. The transceiver 23 may include Nᵣ (where Nᵣ is a positive integer) receive antennas and frequency down-converts each signal received through receive antennas into a baseband signal. The processor 21 decodes and demodulates the radio signals received through the receive antennas and restores data that the transmitting device 100 intended to transmit.

The transceivers 13 and 23 include one or more antennas. An antenna performs a function for transmitting signals processed by the transceivers 13 and 23 to the exterior or receiving radio signals from the exterior to transfer the radio signals to the transceivers 13 and 23. The antenna may also be called an antenna port. Each antenna may correspond to one physical antenna or may be configured by a combination of more than one physical antenna element. The signal transmitted from each antenna cannot be further deconstructed by the receiving device 200. An RS transmitted through a corresponding antenna defines an antenna from the view point of the receiving device 200 and enables the receiving device 200 to derive channel estimation for the antenna, irrespective of whether the channel represents a single radio channel from one physical antenna or a composite channel from a plurality of physical antenna elements including the antenna. That is, an antenna is defined such that a channel carrying a symbol of the antenna can be obtained from a channel carrying another symbol of the same antenna. A transceiver supporting a MIMO function of transmitting and receiving data using a plurality of antennas may be connected to two or more antennas. The transceivers 13 and 23 may be referred to as radio frequency (RF) units.

In the embodiments of the present invention, a UE operates as the transmitting device 100 in UL and as the receiving device 200 in DL. In the embodiments of the present invention, an eNB operates as the receiving device 200 in UL and as the transmitting device 100 in DL. Hereinafter, a processor, a transceiver, and a memory included in the UE will be referred to as a UE processor, a UE transceiver, and a UE memory, respectively, and a processor, a transceiver, and a memory included in the eNB will be referred to as an eNB processor, an eNB transceiver, and an eNB memory, respectively.

The eNB processor may be configured to control the eNB transceiver to transmit RACH configuration information including RACH parameters used in the present invention. The UE transceiver may receive the RACH configuration information and provide it to the UE processor. The UE processor may be configured to control the UE transceiver to perform random access procedure(s) based on the RACH configuration information.

For example, the UE processor may be configured to control the UE transceiver to perform a random access preamble (Msg1) transmission of a random access procedure. The UE processor controls the UE transceiver to receive a random access response (Msg2) of the random access procedure in response to the Msg1 transmission. If the UE processor detects a UL grant for the UE in the Msg2, the UE processor may control the UE transceiver to perform an Msg3 transmission of the random access procedure. The UE processor starts a contention resolution timer, which specifies a duration during which the UE is to monitor a physical downlink control channel (PDCCH) after the Msg3 transmission, when performing the Msg3 transmission of the random access procedure. In the present invention, the UE processor may start a backoff procedure at a time when the UE processor detects that the Msg3 transmission of the random access procedure is not successful, even before the contention resolution timer expires, if the Msg3 transmission of the random access procedure is a last Msg3 transmission of the random access procedure.

In the present invention, the UE processor may stop the contention resolution timer at the time when the UE processor detects that the Msg3 transmission of the random access procedure is not successful, if the Msg3 transmission of the random access procedure is the last Msg3 transmission of the random access procedure. The UE processor may consider that a contention resolution for the random access procedure is not successful if the UE processor detects that the last Msg3 transmission of the random access procedure is not successful. The UE processor may control the UE transceiver to perform a subsequent random access procedure when a backoff time passes after starting the backoff procedure. The UE processor may discard a temporary C-RNTI conveyed in the Msg2, if the Msg3 transmission of the random access procedure is the last Msg3 transmission of the random access procedure and if a contention resolution for the random access procedure is not successful.

The UE processor may control the UE transceiver to receive information on a maximum number (maxHARQ-Msg3Tx) of Msg3 transmissions. The RACH configuration information may include the maximum number (maxHARQ-Msg3Tx) of Msg3 transmissions. If CURRENT_TX_NB for the Msg3 transmission is equal to maxHARQ-Msg3Tx minus 1, the UE processor may consider that the Msg3 is the last Msg3 transmission of the random access procedure, where CURRENT_TX_NB is the number of transmissions that have taken place for Msg3 of the random access procedure.

The UE processor may control the UE transceiver to perform another Msg3 transmission of the random access procedure after the contention resolution timer expires, if the Msg3 transmission is not the last Msg3 transmission of the random access procedure and if the Msg3 transmission is not successful.

The UE processor may consider that the Msg3 transmission of the random access procedure is not successful, if a positive acknowledgement for the Msg3 transmission is not received at a HARQ feedback reception time for the Msg3 transmission, if a negative acknowledgement for the Msg3 transmission is received at the HARQ feedback reception time for the Msg3 transmission, if any HARQ feedback for the Msg3 retransmission is received until the HARQ feedback reception time, or if a PDCCH with a new data indicator (NDI) not toggled compared to a previous NDI for a HARQ process used for the Msg3 retransmission is received at the HARQ feedback reception time for the Msg3 transmission.

As described above, the detailed description of the preferred embodiments of the present invention has been given to enable those skilled in the art to implement and practice the invention. Although the invention has been described with reference to exemplary embodiments, those skilled in the art will appreciate that various modifications and variations can be made in the present invention without departing from the spirit or scope of the invention described in the appended claims. Accordingly, the invention should not be limited to the specific embodiments described herein, but should be accorded the broadest scope consistent with the principles and novel features disclosed herein.

### INDUSTRIAL APPLICABILITY

The embodiments of the present invention are applicable to a network node (e.g., BS), a UE, or other devices in a wireless communication system.

1. A method for performing a random access procedure by a user equipment (UE), the method comprising:
performing a random access preamble (Msg1) transmission of the random access procedure;
receiving a random access response (Msg2) of the random access procedure;
performing an Msg3 transmission of the random access procedure;
starting a contention resolution timer, which specifies a duration during which the UE is to monitor a physical downlink control channel (PDCCH) after the Msg3 transmission, when performing the Msg3 transmission of the random access procedure; and
starting a backoff at a time when the UE detects that the Msg3 transmission of the random access procedure is not successful before the contention resolution timer expires, if the Msg3 transmission of the random access procedure is a last Msg3 transmission of the random access procedure.

2. The method according to claim 1, further comprising:
stopping the contention resolution timer at the time when the UE detects that the Msg3 transmission of the random access procedure is not successful, if the Msg3 transmission of the random access procedure is the last Msg3transmission of the random access procedure.

3. The method according to claim 1,
wherein the UE considers that a contention resolution for the random access procedure is not successful if the UE detects that the last Msg3 transmission of the random access procedure is not successful.

4. The method according to claim 1, further comprising:
performing a subsequent random access procedure when a backoff time passes after starting the backoff.

5. The method according to claim 1, further comprising;
discarding a temporary C-RNTI conveyed in the Msg2, if the Msg3 transmission of the random access procedure is the last Msg3 transmission of the random access procedure and if a contention resolution for the random access procedure is not successful.

6. The method according to claim 1, further comprising:
receiving information on a maximum number (maxHARQ-Msg3Tx) of Msg3 transmissions,
wherein if CURRENT_TX_NB for the Msg3 transmission is equal to maxHARQ-Msg3Tx minus 1, the Msg3 transmission is the last Msg3 transmission of the random access procedure, where CURRENT_TX_NB is the number of transmissions that have taken place for Msg3 of the random access procedure.

7. The method according to claim 1, further comprising:
performing another Msg3 transmission of the random access procedure after the contention resolution timer expires, if the Msg3 transmission is not the last Msg3 transmission of the random access procedure and if the Msg3 transmission is not successful.

8. The method according to claim 1,
wherein the Msg3 transmission of the random access procedure is not successful if a positive acknowledgement for the Msg3 transmission is not received at a HARQ feedback reception time for the Msg3 transmission, if a negative acknowledgement for the Msg3 transmission is received at the HARQ feedback reception time for the Msg3 transmission, if any HARQ feedback for the Msg3 retransmission is received until the HARQ feedback reception time, or if a PDCCH with a new data indicator (NDI) not toggled compared to a previous NDI for a HARQ process used for the Msg3 retransmission is received at the HARQ feedback reception time for the Msg3 transmission.

9. A user equipment (UE) for performing a random access procedure, the UE comprising:
a transceiver, and
a processor configured to control the transceiver, the processor configured to:
control the transceiver to perform a random access preamble (Msg1) transmission of the random access procedure;
control the transceiver to receive a random access response (Msg2) of the random access procedure;
control the transceiver to perform an Msg3 transmission of the random access procedure;
start a contention resolution timer, which specifies a duration during which the UE is to monitor a physical downlink control channel (PDCCH) after the Msg3 transmission, when performing the Msg3 transmission of the random access procedure; and
start a backoff at a time when it is detected that the Msg3 transmission of the random access procedure is not successful before the contention resolution timer expires, if the Msg3 transmission of the random access procedure is a last Msg3 transmission of the random access procedure.

10. The UE according to claim 9,
wherein the processor is configured to stop the contention resolution timer at the time when the UE processor detects that the Msg3 transmission of the random access procedure is not successful, if the Msg3 transmission of the random access procedure is the last Msg3 transmission of the random access procedure.

11. The UE according to claim 9,
wherein the processor is configured to consider that a contention resolution for the random access procedure is not successful if the UE processor detects that the last Msg3 transmission of the random access procedure is not successful.

12. The UE according to claim 9,
wherein the processor is configured to control the transceiver to perform a subsequent random access procedure when a backoff time passes after starting the backoff.

13. The UE according to claim 9,
wherein the processor is configured to discard a temporary C-RNTI conveyed in the Msg2, if the Msg3 transmission of the random access procedure is the last Msg3 transmission of the random access procedure and if a contention resolution for the random access procedure is not successful.

14. The UE according to claim 9,
wherein the processor is configured to control the transceiver to receive information on a maximum number (maxHARQ-Msg3Tx) of Msg3 transmissions, and
wherein if CURRENT_TX_NB for the Msg3 transmission is equal to maxHARQ-Msg3Tx minus 1, the Msg3 transmission is the last Msg3 transmission of the random access procedure, where CURRENT_TX_NB is the number of transmissions that have taken place for Msg3 of the random access procedure.

15. The UE according to claim 9,
wherein the processor is configured to control the transceiver to perform another Msg3 transmission of the random access procedure after the contention resolution timer expires, if the Msg3 transmission is not the last Msg3 transmission of the random access procedure and if the Msg3 transmission is not successful.

16. The UE according to claim 9,
wherein the Msg3 transmission of the random access procedure is not successful if a positive acknowledgement for the Msg3 transmission is not received at a HARQ feedback reception time for the Msg3 transmission, if a negative acknowledgement for the Msg3 transmission is received at the HARQ feedback reception time for the Msg3 transmission, if any HARQ feedback for the Msg3 retransmission is received until the HARQ feedback reception time, or if a PDCCH with a new data indicator (NDI) not toggled compared to a previous NDI for a HARQ process used for the Msg3 retransmission is received at the HARQ feedback reception time for the Msg3 transmission.
